(19) United States
(12) Patent Application Publication
(10) Pub. No.: US 2016/0161666 A1
(43) Pub. Date: Jun. 9, 2016

(54) Backlight Assembly with Lightproof Arrangement

(71) Applicant: Szu-Wei Sun, Pingzhen City (TW)

(72) Inventor: Szu-Wei Sun, Pingzhen City (TW)

(21) Appl. No.: 14/562,802

(22) Filed: Dec. 8, 2014

(51) Int. Cl. F21V 8/00

(52) U.S. Cl. CPC G02B 6/0088; G02B 6/0073; G02B 6/0055; G02B 6/0031

(57) ABSTRACT

A backlight assembly is provided with upper and lower reflective layers secured together and folded to form a concealed space; a light guide layer in the space and including at least one light entrance; an opaque blocking layer at either side portion joining the upper and lower reflective layers; and at least one light source each at the light entrance. Light emitted by the light source travels to the light entrance, and further travels to predetermined areas via paths defined by the upper and lower reflective layers. Light leaking is decreased to a minimum during light transmitting.

### BACKGROUND OF THE INVENTION

1. Field of the Invention

The invention relates to backlight assembly and more particularly to a backlight assembly having a lightproof arrangement so that light with enhanced brightness is transmitted to predetermined positions (i.e., bottoms of keycaps of a keyboard or keypad) of a 3C (computer, communication, and consumer electronics) product with light leaking decreased to a minimum during light transmitting.

2. Description of Related Art

Backlight is widely used in many electronic products and lights such as keyboards, keypads, notebook computers, mobile phones, and displays. A conventional backlight assembly is comprised of a light guide layer, a reflector plate, a light shading plate and circuit board. The plates are manufactured separately prior to stacking in the manufacturing process. However, light may be leaked as it passes through multi-structure consisting of the light guide layer, the reflector plate, the light shading plate and the circuit board. As such, insufficient light is transmitted to predetermined positions (i.e., bottoms of keycaps of a keyboard or keypad) of a 3C product. As a result, backlight efficiency is greatly decreased.

Thus, the need for improvement still exists.

### SUMMARY OF THE INVENTION

It is therefore one object of the invention to provide a backlight assembly comprising upper and lower reflective layers secured together and folded to form a concealed space; a light guide layer disposed in the space and including at least one light entrance; an opaque blocking layer disposed at either side portion joining the upper and lower reflective layers; and at least one light source each disposed at the light entrance; wherein light emitted by the at least one light source travels to the at least one light entrance, and further travels to predetermined areas via paths defined by the upper and lower reflective layers.

The above and other objects, features and advantages of the invention will become apparent from the following detailed description taken with the accompanying drawings.

### BRIEF DESCRIPTION OF THE DRAWINGS

FIG. 1 is a perspective view of an opaque blocking layer and upper and lower reflective layers of a backlight assembly according to a first preferred embodiment of the invention;

FIG. 2 is an exploded view of a backlight assembly according to a first preferred embodiment of the invention;

FIG. 3 is a longitudinal sectional view of the backlight assembly of FIG. 2;

FIG. 4 is an exploded view of a backlight assembly according to a second preferred embodiment of the invention; and

FIG. 5 is a longitudinal sectional view of the backlight assembly of FIG. 4.

### DETAILED DESCRIPTION OF THE INVENTION

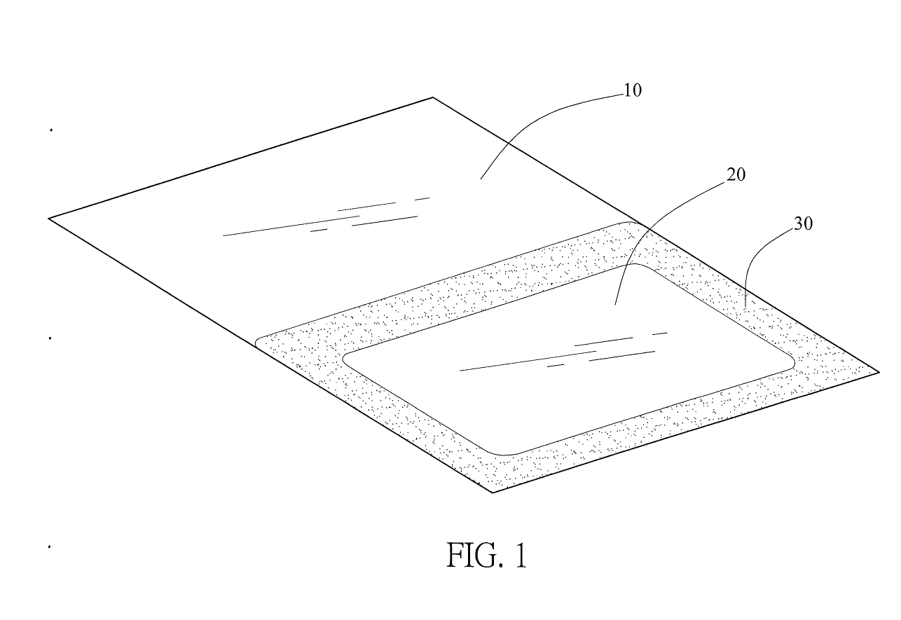

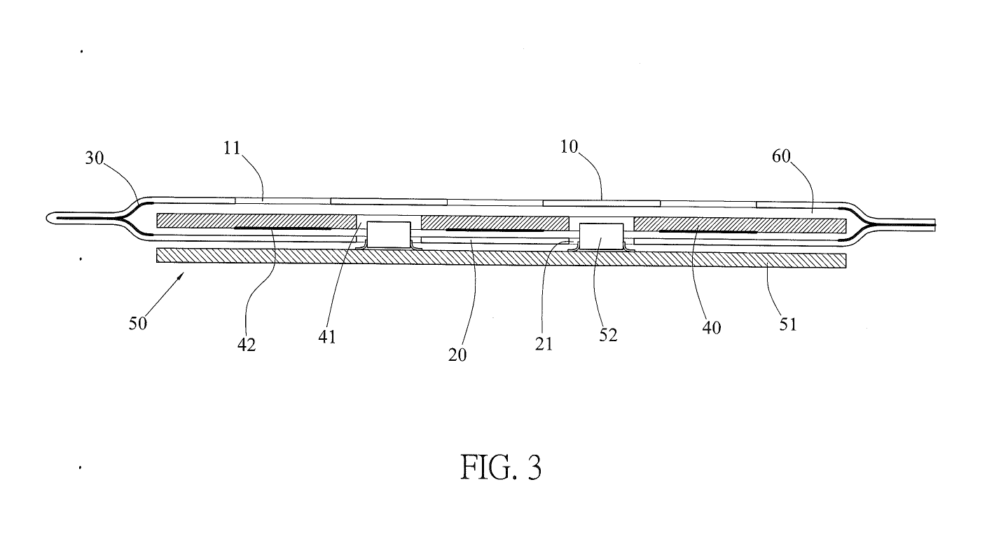

Referring to FIGS. 1 to 3, a backlight assembly in accordance with a first preferred embodiment of the invention comprises the following components as discussed in detail below.

An upper reflective layer 10 and a lower reflective layer 20 are provided. The upper and lower reflective layers 10, 20 are unitary and folded to form a concealed space 60 therebetween. The upper reflective layer 10 includes a plurality of transparent areas 11 and the lower reflective layer 20 includes a plurality of through holes 21. A light guide layer 40 is provided in the space 60. An opaque blocking layer 30 is provided at either portion joining the upper and lower reflective layers 10, 20. The opaque blocking layer 30 is adjacent to the light guide layer 40. The light guide layer 40 includes a plurality of through holes 41 directly above the through holes 21, and a plurality of reflective areas 42, on the underside, the reflective areas 42 being beneath the transparent areas 11. A light source 50 includes a light emitting circuit 51 and a plurality of light-emitting diodes (LEDs) 52 formed on the light emitting circuit 51. The light source 50 is provided under the lower reflective layer 20. The LEDs 52 pass through the through holes 21 to partially dispose in the through holes 41. Also, the LEDs 52 are under but not aligned with the transparent areas 11.

Alternatively, the light source 50 is provided under the light guide layer 40 and the LEDs 52 are partially disposed in the through holes 41.

Still alternatively, the light source 50 is provided above the lower reflective layer 20 with the light emitting circuit 51 provided on the lower reflective layer 20. The LEDs 52 are partially disposed in the through holes 41.

Preferably, the opaque blocking layer 30 is either a dark ink layer or an ink layer of low. The opaque blocking layer 30 occupies an area greater than or equal to either side portion of the light guide layer 40.

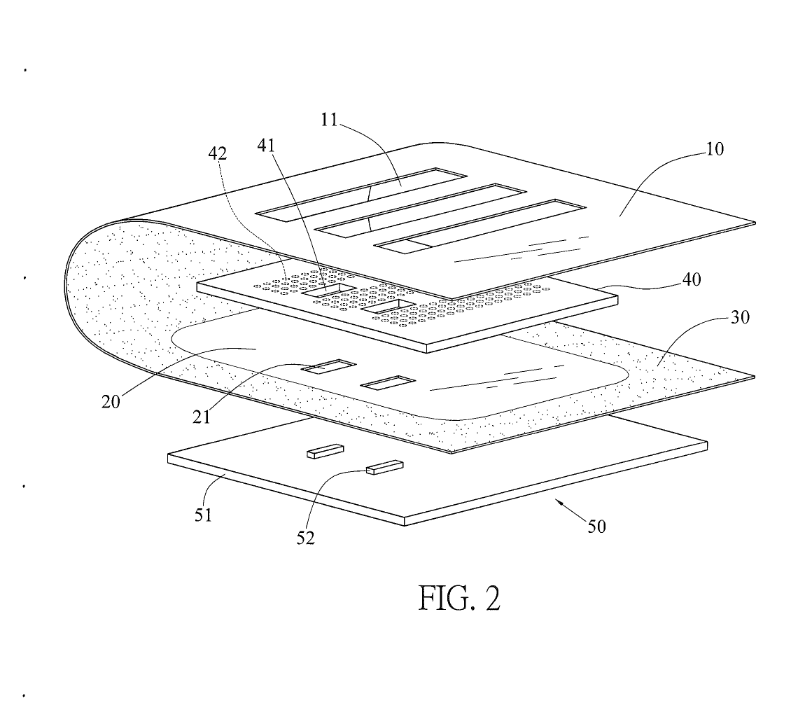

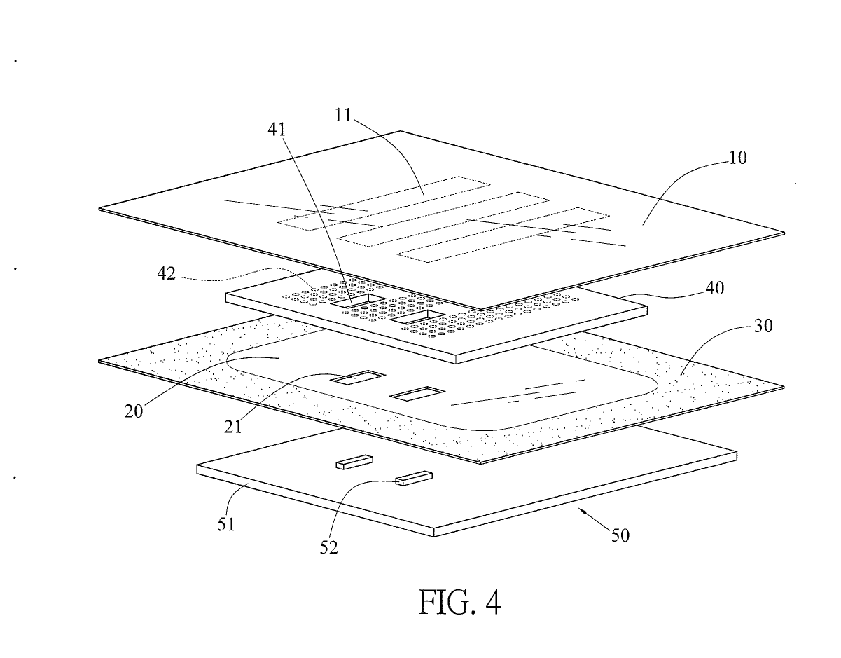

Preferably, the transparent areas 11 are through holes (see FIG. 2) or transparent zones (see FIG. 4).

In operation, light emitted by the LEDs 52 may pass through the lower reflective layer 20 and the light guide layer 40. Further, a portion of the light is reflected toward the transparent areas 11. Both the light from the through holes 41 and the reflected light travel upward toward predetermined areas for illumination.

In the manufacturing process, the upper and lower reflective layers 10, 20 are folded from a unitary member. Further, ends of the unitary upper and lower reflective layers 10, 20 are adhesively secured together to contain the light guide layer 40.

Preferably, both the upper and lower reflective layers 10, 20 are opaque reflective layers.

Preferably, both the upper and lower reflective layers 10, 20 are white, silver, or gray reflective layers.

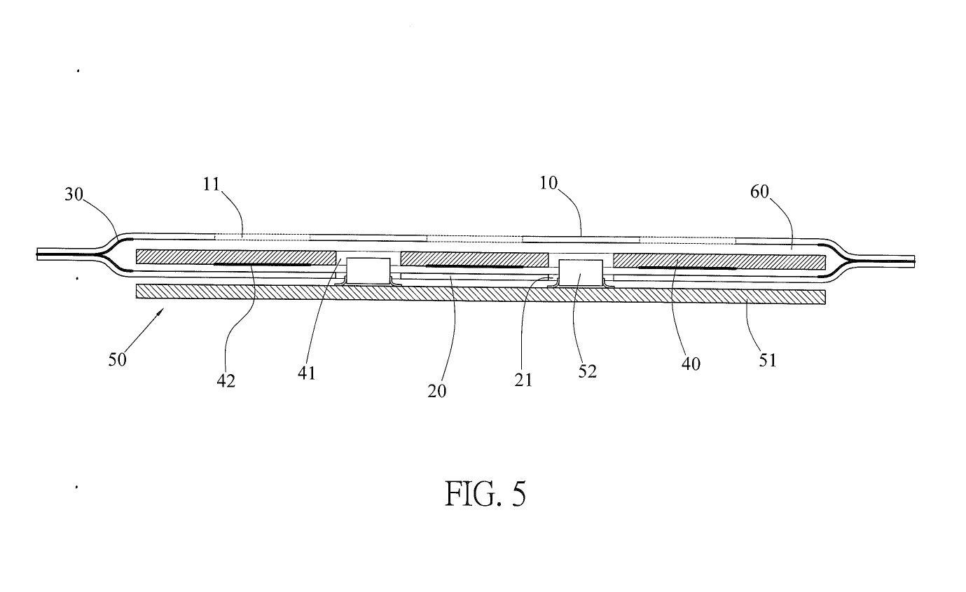

Referring to FIGS. 4 and 5, a backlight, assembly in accordance with a second preferred embodiment of the invention is shown. The characteristics of the second preferred embodiment are substantially the same as that of the first preferred embodiment except the following:

The upper reflective layer 10 and the lower reflective layer 20 are unitary respectively. Ends of the upper and lower reflective layers 10, 20 are adhesively secured together, and the light guide layer 40 is concealed by and between the upper and lower reflective layers 10, 20.

In operation, light emitted by the LEDs 52 may pass through the lower reflective layer 20 and the light guide layer 40. Further, a portion of the light is reflected toward the transparent areas 11. Both the light from the through holes 41 and the reflected light travel upward toward predetermined areas for illumination.

It is envisaged by the invention that the ink on the opaque blocking layers 30 is impervious to light. Light is prevented from leaving the space 60 via the sides. Therefore, light leaking is decreased to a minimum during light transmitting. As a result, light with enhanced brightness is transmitted to the predetermined positions (i.e., bottoms of keycaps of a keyboard or keypad) of a 3C product for illumination.

While the invention has been described in terms of preferred embodiments, those skilled in the art will recognize that the invention can be practiced with modifications within the spirit and scope of the appended claims.

What is claimed is:

1. A backlight assembly comprising:
upper and lower reflective layers secured together and folded to form a concealed space;
a light guide layer disposed in the space and including at least one light entrance;
an opaque blocking layer disposed at either side portion joining the upper and lower reflective layers; and
at least one light source each disposed at the light entrance;
wherein light emitted by the at least one light source travels to the at least one light entrance, and further travels to predetermined areas via paths defined by the upper and lower reflective layers.

2. The backlight assembly of claim 1, wherein the at least one light entrance each is provided a through hole, and wherein the at least one light source each includes a light emitting circuit and a plurality of light-emitting diodes (LEDs) each disposed in the through hole.

3. The backlight assembly of claim 1, wherein the opaque blocking layer is either a dark ink layer or an ink layer of low refractivity.

4. The backlight assembly of claim 1, wherein the upper reflective layer includes a plurality of transparent areas each beneath a predetermined position to be illuminated.

5. The backlight assembly of claim 4, wherein the light guide layer includes a plurality of reflective areas on an underside, the reflective areas being beneath the transparent areas, the reflective areas each being configured to reflect light to the predetermined position to be illuminated.

6. The backlight assembly of claim 1, wherein the upper and lower reflective layers are folded from a unitary member, ends of the upper and lower reflective layers being adhesively secured together to contain the light guide layer.

7. The backlight assembly of claim 1, wherein the upper reflective layer and the lower reflective layer are unitary respectively, ends of the upper and lower reflective layers are adhesively secured together to contain the light guide layer.

8. The backlight assembly of claim 5, wherein both the upper and lower reflective layers are white, silver, or gray reflective layers.

9. The backlight assembly of claim 6, wherein both the upper and lower reflective layers are white, silver, or gray reflective layers.

10. The backlight assembly of claim 4, wherein the transparent areas are either through holes or transparent zones.
